(19) United States
(12) Patent Application Publication
(10) Pub. No.: US 2024/0116038 A1
(43) Pub. Date: Apr. 11, 2024

(54) ZEOLITIC MATERIAL HAVING A CHA-LIKE FRAMEWORK STRUCTURE AND SYNTHESIS OF THE SAME

(71) Applicant: BASF Corporation, Florham Park, NJ (US)

(72) Inventors: Xiaoduo Qi, Shanghai (CN); Lihua Shi, Dalian (CN); Vivek Vattipalli, Iselin, NC (US); Mingming Wei, Shanghai (CN); Haitao Liu, Dalian (CN); Jin Li, Shanghai (CN)

(73) Assignee: BASF Corporation, Florham Park, NJ (US)

(21) Appl. No.: 18/262,884

(22) PCT Filed: Jan. 30, 2022
(86) PCT No.: PCT/CN2022/075138

§ 371 Date: Jul. 25, 2023

(51) Int. Cl. B01J 29/76; B01D 53/94; B01J 37/00; B01J 37/03; B01J 37/04; B01J 37/08; B01J 37/30; C01B 39/02; C01B 39/48; F01N 3/20; F01N 3/28

(52) U.S. Cl. CPC B01J 29/763; B01D 53/9418; B01J 37/0018; B01J 37/031; B01J 37/04; B01J 37/08; B01J 37/30; C01B 39/026; C01B 39/48; F01N 3/2066; F01N 3/2803; B01D 2255/20761; B01D 2255/50; B01D 2255/9207; B01D 2257/404; B01D 2258/01; B01J 2229/186; C01P 2002/72; C01P 2002/74; C01P 2002/78; C01P 2004/03; C01P 2006/12; F01N 2370/04

(57) ABSTRACT

The present invention relates to a CHA-like zeolitic material having an X-ray diffraction pattern including the following peaks in Table 1 in its as-synthesized form, and to a process for preparing the zeolitic material, and use of the zeolitic material for the selective catalytic reduction of NOx.

### FIELD OF THE INVENTION

The present invention relates to a zeolitic material having a CHA-like framework structure, a process for preparing the zeolitic material, and use of the zeolitic material for the selective catalytic reduction of NOx.

### BACKGROUND

Molecular sieves such as zeolites are useful as catalysts for certain reactions, for example for selective catalytic reduction (SCR) of nitrogen oxides (NOx) with a reductant such as ammonia, urea or hydrocarbons.

Zeolites, although occurring naturally, have also been synthesized. One typical process for synthesis of a zeolitic material includes providing a synthesis mixture comprising one or more source materials for the framework structure and one or more of a structure directing agent and optionally a seed crystal, also known as synthesis gel, and applying hydrothermal conditions on the synthesis mixture for crystallizing a zeolitic material. An extensive compilation of syntheses of zeolitic materials is given in the textbook Verified Syntheses of Zeolitic Materials, Harry Robson, 2^{nd} revised edition, Elsevier, Amsterdam (2001).

Owing to the effort involved in the zeolite synthesis, 252 zeolites having a different framework structure or partially disordered structure have been approved by August 2020, according to the online database of the International Zeolite Association. However, computer calculations predicted that millions of hypothetical zeolite structures are possible. It is a fact that only a small fraction of the possibilities was realized.

### SUMMARY OF THE INVENTION

It was an object of the present invention to provide a novel zeolitic material which has different framework and/or composition from that of any known zeolitic materials, in particular a zeolitic material useful for selective catalytic reduction of nitrogen oxides (NOx).

It has surprisingly been found that the object was achieved by a process for preparing a zeolitic material using an imidazolium cation containing compound as an organic structure directing agent (OSDA).

Accordingly, in one aspect, the present invention relates to a process for preparing a CHA-like zeolitic material, the process comprising
(1) providing a synthesis mixture comprising
   (a) a source for X₂O₃ where X is a trivalent framework element,
   (b) a source for YO₂ where Y is a tetravalent framework element, and
   (c) an imidazolium based organic structure directing agent, and
(2) heating the synthesis mixture to form a zeolitic material.

In another aspect, the present invention relates to a CHA-like zeolitic material, particularly a CHA-like zeolitic material having an X-ray diffraction pattern including the following peaks, in its as-synthesized form:

| 2-Theta | d-spacing | Relative Intensity |
|---|---|---|
| (±0.3°) | (Å) | (±30%) |
| 9.56 | 9.24 | 71 |
| 16.00 | 5.54 | 67 |
| 20.54 | 4.32 | 100 |
| 22.38 | 3.97 | 21 |
| 25.58 | 3.48 | 74 |
| 25.78 | 3.45 | 30 |
| 30.48 | 2.93 | 47 |

In still another aspect, the present invention relates to use of the CHA-like zeolitic material as described herein as a catalyst and/or as a catalyst component, preferably as a catalyst and/or a catalyst component for the selective catalytic reduction (SCR) of nitrogen oxides NOx.

In a further aspect, the present invention relates to a catalytic article comprising a catalytic coating on a substrate, wherein the catalytic coating comprises the CHA-like zeolitic material.

In a still further aspect, the present invention relates to an exhaust gas treatment system comprising an internal combustion engine and an exhaust gas conduit in fluid communication with the internal combustion engine, wherein catalytic article as described herein is present in the exhaust gas conduit.

### BRIEF DESCRIPTION OF THE DRAWINGS

FIG. 1 shows SEM images of the zeolitic materials from Example 1.1, 1.2, 2, 3 and 4 respectively.

FIG. 2 shows XRD patterns of the zeolitic materials from Examples 1.2 and Examples 2, 3 and 4, in respective as-synthesized forms.

FIG. 3 shows XRD patterns of the zeolitic materials from Examples 1.2 and Examples 2, 3 and 4, in respective calcined forms.

FIG. 4 shows NOx removal performance of the Cu-promoted catalyst based on the CHA-like zeolitic materials from Example 1.1.

### DETAlLED DESCRIPTION OF THE INVENTION

The present invention will be described in detail hereinafter. It is to be understood that the present invention may be embodied in many different ways and shall not be construed as limited to the embodiments set forth herein.

Herein, the singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

The term “CHA” as used herein refer to CHA framework type as recognized by the International Zeolite Association (IZA) Structure Commission.

The term “CHA-like zeolitic material”, “CHA-like zeolite”, “CHA-like framework” and the like as used herein is intended to refer to a material which shows an XRD pattern of a CHA framework structure in its calcined form, and shows an XRD pattern different from a CHA framework structure in its as-synthesized form. The term CHA-like zeolitic material is also intended to include any forms of the zeolite, including for example as-synthesized form, calcined form, NH₄-form, H-form and metal-loaded H-form, unless specified otherwise.

The term “as-synthesized” as used herein is intended to refer to a zeolitic material in its form after crystallization and drying, prior to removal of the organic template.

As to step (1), the synthesis mixture useful for the preparation of the CHA-like zeolitic material according to the present invention may comprise:
(a) a source for X₂O₃ where X is a trivalent element,
(b) a source for YO₂ where Y is a tetravalent element, and
(c) an imidazolium based organic structure directing agent.

In the context of the present invention, X may be any trivalent element. Preferably, X is selected from the group consisting of Al, B, In and Ga and any combinations thereof, wherein Al is more preferable. In the context of the present invention, Y may be any tetravalent element. Preferably, Y is selected from the group consisting of Si, Sn, Ti, Zr, Ge and any combinations thereof, wherein Si is more preferable.

In a particular embodiment of the process according to the present invention, X is Al and Y is Si. Accordingly, a CHA-like aluminosilicate zeolitic material will be provided by the process according to the particular embodiment.

Suitable source for X₂O₃ may be any known materials useful for providing trivalent framework element during zeolite synthesis. In a particular embodiment wherein X is Al, suitable examples of the source for Al₂O₃ may include, but are not limited to alumina, aluminates, aluminum alkoxides, aluminum salts, FAU zeolites, LTA zeolites, LTL zeolites, BEA zeolites, MFI zeolites and any combinations thereof, more preferably alumina, aluminum alkoxide, aluminum salts, FAU zeolites and any combinations thereof, more preferably alumina, aluminum tri(C₁-C₅)alkoxide, AlO(OH), Al(OH)₃, aluminum halides, aluminum sulfate, aluminum phosphate, aluminum fluorosilicate, FAU zeolites and any combinations thereof. For example, the FAU zeolite may be selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na-X, US-Y, ECR-30, LZ-210, Li-LSX, SAPO-37, Na-Y, ZSM-20, ZSM-3, Zeolite X and Zeolite Y, more preferably from the group consisting of faujasite, Na-X, US-Y, LZ-210, zeolite X and zeolite Y. In some embodiments, zeolite Y and/or US-Y is particularly useful as the source for X₂O₃, and zeolite Y is most useful.

Suitable source for YO₂ may be any known materials useful for providing tetravalent framework element during zeolite synthesis. In a particular embodiment wherein Y is Si, suitable sources for YO₂ may include, but are not limited to fumed silica, precipitated silica, silica hydrosols, silica gels, colloidal silica, silicic acid, silicon alkoxides, alkali metal silicates, sodium metasilicate hydrate, sesquisilicate, disilicate, silicic acid esters, FAU zeolites, LTA zeolites, LTL zeolites, BEA zeolites, MFI zeolites and any combinations thereof, preferably fumed silica, sodium silicate, potassium silicate, FAU zeolites and any combinations thereof, more preferably fumed silica, FAU zeolites and any combinations thereof. For example, the FAU zeolite may be selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na-X, US-Y, ECR-30, LZ-210, Li-LSX, SAPO-37, Na-Y, ZSM-20, ZSM-3, Zeolite X and Zeolite Y, more preferably from the group consisting of faujasite, Na-X, US-Y, LZ-210, zeolite X and zeolite Y. In some embodiments, one or more materials selected from the group consisting of fumed silica, precipitated silica, silica hydrosols, silica gels, colloidal silica, zeolite Y and US-Y are particularly useful as the source for YO₂.

Preferably, the synthesis mixture provided in step (1) has a YO₂: X₂O₃ molar ratio of the source for YO₂ calculated as YO₂ to the source for X₂O₃ calculated as X₂O₃ in the range of from 5 to 80, for example 15 to 40, such as 20 to 35, or for example 60 to 80, such as 65 to 75.

The imidazolium based organic structure directing agent may be any compounds containing optionally substituted imidazolium cation (Q) with no particular restriction. Preferably, the imidazolium based organic structure directing agent is selected from the group consisting of compounds containing an imidazolium cation of formula (I):

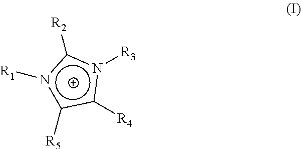

in which
R₁, R₂, R₃, R₄ and R₅, independently from each other, are selected from H, linear or branched alkyl and mono-, bi- or tricycloalkyl, provided that at least one of R₁ and R₃ is not H.

The term “alkyl” as used herein refers to a linear, branched, or cyclic saturated hydrocarbon group. The linear or branched alkyl group herein typically has 1 to 10 carbon atoms, for which methyl, ethyl, n-propyl, iso-propyl, n-butyl, isobutyl, t-butyl, pentyl, hexyl, heptyl, octyl and decyl may be exemplified. The cycloalkyl group herein typically has 3 to 8 carbon atoms in each ring, for which cyclopropyl, cyclobutyl, cyclopentyl, cyclohexyl, cycloheptyl, cyclooctyl and adamantyl may be exemplified.

In some embodiments, the imidazolium based organic structure directing agent is selected from the group consisting of compounds containing an imidazolium cation of formula (I) in which R₁, R₂, R₃, R₄ and R₅, independently from each other, are selected from H and linear or branched C₁-C₁₀ alkyl, provided that at least one of R, and R₃ is not H.

In some further embodiments, the imidazolium based organic structure directing agent is selected from the group consisting of compounds containing an imidazolium cation of formula (Ia),

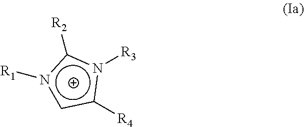

in which
R₁, R₂ and R₄, independently from each other, are selected from the group consisting of H and linear or branched C₁-C₁₀ alkyl, and
R₃ is selected from linear or branched C₁-C₁₀ alkyl.

In some particular embodiments, the imidazolium based organic structure directing agent is selected from the group consisting of compounds containing an imidazolium cation of formula (Ia), in which R₁, R₂ and R₄, independently from each other, are selected from the group consisting of H and linear or branched C₁-C₆ alkyl, and R₃ is selected from linear or branched C₁-C₆ alkyl.

In some preferable embodiments, the imidazolium based organic structure directing agent is selected from the group consisting of compounds containing an imidazolium cation of formula (Ia), in which R₁, R₂ and R₄, independently from each other, are selected from the group consisting of H and linear or branched C₁-C₃ alkyl, and R₃ is selected from linear or branched C₁-C₃alkyl.

In some more preferable embodiments, the imidazolium based organic structure directing agent is selected from the group consisting of compounds containing an imidazolium cation of formula (Ia), in which R₁, R₂ and R₄, independently from each other, are selected from the group consisting of H, methyl, ethyl, n-propyl, iso-propyl and R₃ is selected from the group consisting of methyl, ethyl, n-propyl and iso-propyl.

In some most preferable embodiments, the imidazolium based organic structure directing agent is selected from the group consisting of compounds containing an imidazolium cation selected from the group consisting of 1-ethyl-3-methylimidazolium, 1,3-dimethylimidazolium, 1,3-diethylimidazolium, 1,2,3-trimethylimidazolium, 1,2,3-trimethylimidazolium, 1,2,3-triethylimidazolium, 1,3,4-trimethylimidazolium and 1,3,4-triethylimidazolium.

Useful anions as the counterion contained in the imidazolium based organic structure directing agent may be selected from the group consisting of halide such as fluoride, chloride and bromide, hydroxide, sulfate, nitrate and carboxylate such as acetate; preferably selected from the group consisting of chloride, bromide, hydroxide and sulfate.

Preferably, the imidazolium based organic structure directing agent are hydroxides, chlorides or bromides, and particularly hydroxides of the imidazolium cation of formula (I) or (la) as described herein above.

Preferably, the synthesis mixture provided in step (1) has a Q: YO₂ molar ratio of the imidazolium cation (Q) to the source for YO₂ calculated as YO₂ in the range of from 0.01 to 2, preferably from 0.05 to 1.5, more preferably from 0.1 to 1.0, more preferably from 0.2 to 0.8, most preferably from 0.2 to 0.6, particularly 0.4 to 0.6.

In some embodiments, the synthesis mixture provided in step (1) further comprises at least one solvent, preferably water, more preferably deionized water. Preferably, the synthesis mixture provided in step (1) has a molar ratio H₂O:YO₂ of water to the source for YO₂ calculated as YO₂ in the range of from 3 to 60, preferably from 10 to 35, more preferably from 10 to 25, most preferably 10 to 20. The solvent may be comprised in one or more of starting materials of the synthesis mixture such as sources for X₂O₃, YO₂ and the imidazolium based organic structure directing agent and then incorporated into the synthesis mixture, and/or may be incorporated into the synthesis mixture separately.

In some embodiments, the synthesis mixture provided in step (1) further comprises a source for alkali metal and/or alkaline earth metal cations (AM), preferably alkali metal cations. The alkali metal is preferably selected from the group consisting of Li, Na, K, Cs and any combinations thereof, more preferably Na and/or K, and most preferably Na. The alkaline earth metal is preferably selected from the group consisting of Mg, Ca, Sr and Ba. Useful anions as the counterion of the alkali metal and/or alkaline earth metal cations (AM) are typically halide such as fluoride, chloride and bromide, hydroxide, sulfate, nitrate, carboxylate such as acetate, and any combinations thereof, preferably chloride, bromide, hydroxide, sulfate and any combinations thereof, more preferably hydroxide.

The synthesis mixture provided in step (1) has an AM: YO₂ molar ratio of the alkali metal and/or alkaline earth metal to the source for YO₂ calculated as YO₂ in the range of from 0.01 to 1.0, preferably from 0.1 to 0.8.

In some preferable embodiments, the synthesis mixture provided in step (1) comprises a source for alkali metal cations and has an AM: YO₂ molar ratio of the alkali metal cations to the source for YO₂ calculated as YO₂ in the range of from 0.01 to 1.0, preferably from 0.1 to 0.8, more preferably from 0.3 to 0.7, most preferably from 0.3 to 0.55.

In some embodiments, the synthesis mixture provided in step (1) further comprises a source for the anion OH—. Useful source for OH— may be for example a metal hydroxide such as alkali metal hydroxide or ammonium hydroxide. Preferably, the anion OH— may be originated from the source for alkali metal and/or alkaline earth metal cation and/or the source for the imidazolium based organic structure directing agent.

The synthesis mixture provided in step (1) has an OH—: YO₂ molar ratio of OH— to the source for YO₂ calculated as YO₂ in the range of from 0.1 to 2, more preferably from 0.2 to 1.5, more preferably from 0.5 to 1.2, most preferably from 0.6 to 1.2.

In some embodiments, the synthesis mixture provided in step (1) may further comprise an amount of seed crystals of the CHA-like zeolite. The seed crystals of the CHA-like zeolite may be obtained from process as described herein without using seed crystals.

As to step (2), the synthesis mixture is preferably heated at a temperature in the range of from 80 to 250° C., more preferably from 90 to 230° C., more preferably from 100 to 200° C., more preferably from 110 to 190° C., more preferably from 120 to 170° C., most preferably from 130 to 155° C. The heating may be performed for a period in the range of from 0.25 to 12 days, more preferably from 0.5 to 10 days, more preferably from 1 to 7 days, more preferably from 2 to 6 days. Preferably, the heating is performed under autogenous pressure, more particularly in a pressure tight vessel, more preferably in an autoclave. Further, the heating is preferably performed under agitation.

In a particular embodiment, the heating in step (2) is performed at a temperature in the range of from 120 to 170° C., more preferably from 130 to 155° C., for a period in the range of from 1 to 7 days, preferably 2 to 6 days, under autogenous pressure in a pressure tight vessel, more preferably in an autoclave.

Generally, the zeolitic material formed in step (2) may be subjected to a work-up procedure including isolating for example by filtration, optionally washing, and drying. Accordingly, step (2) in the process according to the present invention optionally further comprises the work-up procedure.

In some embodiments, the zeolitic material from step (2) may be subjected to a calcination procedure. Accordingly, the process according to the present invention further comprises (3) calcining the zeolitic material.

In some embodiments, the zeolitic material may be subjected to an ion-exchange procedure such that one or more of ionic non-framework elements contained in the zeolitic material are exchanged to H⁺ and/or NH₄⁻. Accordingly, the process according to the present invention further comprises
(4) exchanging one or more of ionic non-framework elements contained in the zeolitic material obtained in step (2) or (3) to H⁺ and/or NH₄⁻, preferably NH₄⁻.

Generally, the zeolitic material having been exchanged to H⁺ and/or NH₄⁻ in step (4) may be subjected to a work-up procedure including isolating for example by filtration, optionally washing, and drying, and/or subjected to a calcination procedure. Accordingly, step (4) in the process according to the present invention optionally further comprises the work-up procedure and/or calcination procedure.

In some embodiments, the zeolitic material may be subjected to loading a promoter metal on and/or in the zeolitic material. Accordingly, the process according to the present invention further comprises
(5) loading a precursor of promoter metal on and/or in the zeolitic material obtained in step (3) or (4), preferably by ion-exchanging or impregnation, more preferably incipient wetness impregnation.

The promoter metal may be any metals known useful for improving the catalytic activity of zeolites in catalyst applications, including for example precious metals such as platinum group metal, Au and Ag, transition metals and alkali earth metals. Preferably, the promoter metal is selected from the group consisting of Ca, Mg, Sr, Zr, Cr, Mo, Fe, Mn, V, Co, Ni, Cu, Zn, Ru, Rh, Pd, Ag, Os, Ir, Pt, Au and any combinations thereof, preferably from the group consisting of Ca, Mg, Sr, Cr, Mo, Fe, Mn, V, Co, Ni, Cu, Zn and any combinations thereof, more preferably from the group consisting of Ca, Mn, Fe, Mn, Ni, Cu, Zn and any combinations thereof, wherein Cu and/or Fe are most preferable. Useful precursors of promoter metal may be for example any soluble salts of the promoter metal, any soluble complexes of the promoter metal and a combination thereof.

The promoter metal may be loaded on and/or in the zeolitic material in an amount of 0.1 to about 10% by weight, preferably 0.5 to 10% by weight, more preferably 1 to 10% by weight, particularly 3 to 7% by weight on an oxide basis based on the weight of the metal-promoted zeolite material. Alternatively, the promoter metal may be loaded on and/or in the zeolite material in an amount of 0.1 to 1.0 moles, preferably 0.15 to 0.7 moles, more preferably 0.2 to 0.6 moles, most preferably 0.3 to 0.5 moles per mole of trivalent element in the zeolite material, namely the trivalent framework element of the zeolite material.

Generally, the zeolitic material having been loaded with a promoter metal in step (5) may be subjected to a work-up procedure including isolating, optionally washing and drying, and/or to a calcination procedure. Accordingly, step (5) in the process according to the present invention optionally further comprises the work-up procedure and/or calcination procedure.

Regarding the calcination which is performed in step (3) and optionally performed in step (4) and (5), heating is performed at a temperature in the range of from 300 to 900° C., preferably from 350 to 700° C., more preferably from 400 to 650° C., and more preferably from 450 to 600° C. Particularly, the calcination may be performed in a gas atmosphere having a temperature in the above described ranges, which may be air, oxygen, nitrogen, or a mixture of two or more thereof. Preferably, the calcination is performed for a period in the range of from 0.5 to 10 h, preferably from 3 to 7 h, more preferably from 4 to 6 h.

The present invention further relates to the CHA-like zeolitic material obtainable or obtained from the process as described herein above. It will be understood that the zeolitic material may be the product obtainable or obtained directly from step (3), step (4) or step (5), depending on the steps actually performed in the process as described herein above.

Further, the present invention relates to a CHA-like zeolitic material having, in its as-synthesized form, an X-ray powder diffraction pattern including at least the peaks listed in Table 1 below.

TABLE 1

| 2-Theta | d-spacing | Relative Intensity |
|---|---|---|
| (±0.3°) | (Å) | (±30%) |
| 9.56 | 9.24 | 71 |
| 16.00 | 5.54 | 67 |
| 20.54 | 4.32 | 100 |
| 22.38 | 3.97 | 21 |
| 25.58 | 3.48 | 74 |
| 25.78 | 3.45 | 30 |
| 30.48 | 2.93 | 47 |

The CHA-like zeolitic material according to the present invention particularly has, in its as-synthesized form, an X-ray powder diffraction pattern including at least the peaks listed in Table 2 below.

TABLE 2

| 2-Theta | d-spacing | Relative Intensity |
|---|---|---|
| (±0.3°) | (Å) | (±30%) |
| 9.56 | 9.24 | 71 |
| 12.80 | 6.91 | 11 |
| 16.00 | 5.54 | 67 |
| 18.28 | 4.85 | 13 |
| 20.54 | 4.32 | 100 |
| 22.38 | 3.97 | 21 |
| 25.58 | 3.48 | 74 |
| 25.78 | 3.45 | 30 |
| 27.54 | 3.24 | 3 |
| 30.48 | 2.93 | 47 |
| 31.54 | 2.83 | 14 |
| 32.33 | 2.77 | 3 |

The CHA-like zeolitic material according to the present invention more particularly has, in its as-synthesized form, an X-ray powder diffraction pattern including at least the peaks listed in Table 3 below.

TABLE 3

| 2-Theta | d-spacing | Relative Intensity |
|---|---|---|
| (±0.3°) | (Å) | (±30%) |
| 9.56 | 9.24 | 71 |
| 12.80 | 6.91 | 11 |
| 16.00 | 5.54 | 67 |
| 18.28 | 4.85 | 13 |
| 20.54 | 4.32 | 100 |
| 22.38 | 3.97 | 21 |
| 23.14 | 3.84 | 3 |
| 25.58 | 3.48 | 74 |
| 25.78 | 3.45 | 30 |
| 27.54 | 3.24 | 3 |
| 28.69 | 3.11 | 0.4 |
| 29.55 | 3.02 | 2 |
| 30.48 | 2.93 | 47 |
| 31.54 | 2.83 | 14 |
| 32.33 | 2.77 | 3 |
| 34.31 | 2.61 | 13 |

The CHA-like zeolitic material according to the present invention has, in its calcined form, an X-ray powder diffraction pattern including at least the peaks listed in Table 4 below.

TABLE 4

| 2-Theta | d-spacing | Relative Intensity |
|---|---|---|
| (±0.3°) | (Å) | (±30%) |
| 9.60 | 9.21 | 100 |
| 12.97 | 6.82 | 30 |
| 16.15 | 5.48 | 14 |
| 18.09 | 4.90 | 13 |
| 20.76 | 4.27 | 43 |
| 25.34 | 3.51 | 11 |
| 30.84 | 2.90 | 17 |

The CHA-like zeolitic material according to the present invention preferably has a YO₂: X₂O₃ molar ratio in the range of from 5 to 50, preferably from 5 to 35, more preferably from 5 to 25, more preferably from 10 to 24, most preferably 10 to 20 as determined in its calcined H-form.

The crystals of the CHA-like zeolitic material according to the present invention show a mixed morphology, that is, partial crystals show cuboctahedral morphology and the other crystals show non-convex polyhedral morphology, as observed by scanning electron microscopy (SEM).

The CHA-like zeolite material according to the present invention in its as-synthesized form comprises imidazolium cations, particularly imidazolium cations of formula (I) as described hereinabove, more particularly imidazolium cations of formula (Ia) as described hereinabove.

In some embodiments, the CHA-like zeolite material according to the present invention has a mesopore surface area (MSA) of no more than 60 m²/g, or no more than 50 m²/g, or no more than 45 m²/g, for example 10 to 60 m²/g, or 10 to 50 m²/g or 10 to 45 m²/g. Alternatively or additionally, the CHA-like zeolite material according to the present invention has a zeolitic surface area (ZSA) of at least about 400 m²/g, or at least 450 m²/g, for example in the range of 400 to 650 m²/g or 450 to 650 m²/g. The mesopore and zeolitic surface areas may be determined via N₂-adsorption porosimetry.

The CHA-like zeolitic material according to the present invention typically has an average crystal size of up to 1 μm, or in the range of from 200 nm to 1 μm, or 400 nm to 1 μm, or 600 nm to 1 μm. Average crystal sizes may be determined via scanning electron microscopy (SEM). Particularly, the average crystal size was determined via SEM by measuring the crystal sizes for at least 30 different crystals selected at random from multiple images covering different areas of the sample.

The zeolitic material according to the present invention may be used for any conceivable purpose, including, but not limited to, as molecular sieve, as adsorbent, for ion-exchange, or as a catalyst and/or as a catalyst component, preferably as a catalyst for the selective catalytic reduction (SCR) of nitrogen oxides NOx; for the storage and/or adsorption of CO₂; for the oxidation of NH₃, in particular for the oxidation of NH₃ slip in diesel systems; for the decomposition of N₂O; as an additive in fluid catalytic cracking (FCC) processes; and/or as a catalyst in organic conversion reactions, preferably in the conversion of alcohols to olefins.

In some embodiments, the zeolitic material according to the present invention is used for the selective catalytic reduction (SCR) of nitrogen oxides NOx, and more preferably for the selective catalytic reduction (SCR) of nitrogen oxides NOx in exhaust gas from a combustion engine.

For the SCR application, the zeolitic material according to the present invention may be in form of an extruded body or preferably as a washcoat on a substrate. The term “washcoat” has its usual meaning in the art, that is a thin, adherent coating of a catalytic or other material applied to a substrate. The term “substrate” generally refers to a monolithic material onto which a catalytic coating is disposed, for example monolithic honeycomb substrate, particularly flow-through monolithic substrate and wall-flow monolithic substrate. The zeolitic material according to the present invention may be processed into the application form by any known processes with no particular restriction.

Accordingly, the present invention relates to a catalytic article comprising a catalytic coating on a substrate, wherein the catalytic coating comprises the zeolitic material according to the present invention.

In a further embodiment, the present invention relates to an exhaust gas treatment system comprising an internal combustion engine and an exhaust gas conduit in fluid communication with the internal combustion engine, wherein the catalytic article as described above is present in the exhaust gas conduit.

### Embodiments

Various embodiments are listed below. It will be understood that the embodiments listed below may be combined with all aspects and other embodiments in accordance with the scope of the invention.
1. A CHA-like zeolitic material having an X-ray diffraction pattern including the following peaks, in its as-synthesized form:

| 2-Theta | d-spacing | Relative Intensity |
|---|---|---|
| (±0.3°) | (Å) | (±30%) |
| 9.56 | 9.24 | 71 |
| 16.00 | 5.54 | 67 |
| 20.54 | 4.32 | 100 |
| 22.38 | 3.97 | 21 |
| 25.58 | 3.48 | 74 |
| 25.78 | 3.45 | 30 |
| 30.48 | 2.93 | 47 |

preferably having an X-ray diffraction pattern including the following peaks,

| 2-Theta | d-spacing | Relative Intensity |
|---|---|---|
| (±0.3°) | (Å) | (±30%) |
| 9.56 | 9.24 | 71 |
| 12.80 | 6.91 | 11 |
| 16.00 | 5.54 | 67 |
| 18.28 | 4.85 | 13 |
| 20.54 | 4.32 | 100 |
| 22.38 | 3.97 | 21 |
| 25.58 | 3.48 | 74 |
| 25.78 | 3.45 | 30 |
| 27.54 | 3.24 | 3 |
| 30.48 | 2.93 | 47 |
| 31.54 | 2.83 | 14 |
| 32.33 | 2.77 | 3 |

particularly having an X-ray powder diffraction pattern including the following peaks

| 2-Theta | d-spacing | Relative Intensity |
|---|---|---|
| (±0.3°) | (Å) | (±30%) |
| 9.56 | 9.24 | 71 |
| 12.80 | 6.91 | 11 |
| 16.00 | 5.54 | 67 |
| 18.28 | 4.85 | 13 |
| 20.54 | 4.32 | 100 |
| 22.38 | 3.97 | 21 |
| 23.14 | 3.84 | 3 |
| 25.58 | 3.48 | 74 |
| 25.78 | 3.45 | 30 |
| 27.54 | 3.24 | 3 |
| 28.69 | 3.11 | 0.4 |
| 29.55 | 3.02 | 2 |
| 30.48 | 2.93 | 47 |
| 31.54 | 2.83 | 14 |
| 32.33 | 2.77 | 3 |
| 34.31 | 2.61 | 13. |

2. The CHA-like zeolitic material according to Embodiment 1, which has an X-ray diffraction pattern including the following peaks, in its calcined form:

| 2-Theta | d-spacing | Relative Intensity |
|---|---|---|
| (±0.3°) | (Å) | (±30%) |
| 9.60 | 9.21 | 100 |
| 12.97 | 6.82 | 30 |
| 16.15 | 5.48 | 14 |
| 18.09 | 4.90 | 13 |
| 20.76 | 4.27 | 43 |
| 25.34 | 3.51 | 11 |
| 30.84 | 2.90 | 17. |

3. The CHA-like zeolitic material according to Embodiment 1 or 2, which has a mixed morphology wherein partial crystals show cuboctahedral morphology and the other crystals show non-convex polyhedral morphology, as observed by scanning electron microscopy.
4. The CHA-like zeolitic material according to any of Embodiments 1 to 3, which, in its as-synthesized form, comprises imidazolium cations, particularly imidazolium cations of formula (I)

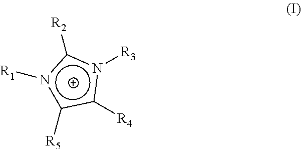

in which
R₁, R₂, R₃, R₄ and R₅, independently from each other, are selected from H, linear or branched alkyl, and mono-, bi- or tricycloalkyl, provided that at least one of R₁ and R₃ is not H;
preferably imidazolium cations of formula (I) in which R₁, R₂, R₃, R₄ and R₅, independently from each other, being selected from H and linear or branched C₁-C₁₀ alkyl, provided that at least one of R₁ and R₃ is not H;
more preferably imidazolium cations of formula (Ia)

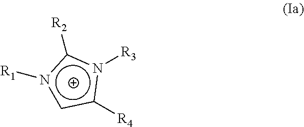

in which
R₁, R₂ and R₄, independently from each other, are selected from the group consisting of H and linear or branched C₁-C₁₀ alkyl, and
R₃ is selected from linear or branched C₁-C₁₀ alkyl.
5. The CHA-like zeolitic material according to Embodiment 4, wherein the imidazolium cations are selected from the group consisting of 1-ethyl-3-methylimidazolium, 1,3-dimethylimidazolium, 1.3-diethylimidazolium, 1,2,3-trimethylimidazolium, 1,2,3-trimethylimidazolium, 1,2,3-triethylimidazolium, 1,3,4-trimethylimidazolium and 1,3,4-triethylimidazolium.
6. The CHA-like zeolitic material according to any of Embodiments 1 to 5, which has at least one of following surface areas:
   (1) a mesopore surface area (MSA) of no more than 60 m²/g, or no more than 50 m²/g, or no more than 45 m²/g, for example 10 to 60 m²/g, or 10 to 50 m²/g or 10 to 45 m²/g; and
   (2) a zeolitic surface area (ZSA) of at least about 400 m²/g, or at least 450 m²/g, for example in the range of 400 to 650 m²/g or 450 to 650 m²/g.
7. The CHA-like zeolitic material according to any of Embodiments 1 to 6, which is an aluminosilicate zeolite.
8. A process for preparing a CHA-like zeolitic material, particularly for preparing a CHA-like material according to any of preceding Embodiments 1 to 7, which comprises
   (1) providing a synthesis mixture comprising
      (a) a source for X₂O₃ where X is a trivalent element,
      (b) a source for YO₂ where Y is a tetravalent element, and
      (c) an imidazolium based organic structure directing agent, and
   (2) heating the synthesis mixture to form a zeolitic material.
9. The process according to Embodiment 8, wherein X is selected from the group consisting of Al, B, In and Ga and any combinations thereof, preferably X being Al.
10. The process according to Embodiment 8 or 9, wherein Y is selected from the group consisting of Si, Sn, Ti, Zr, Ge and any combinations thereof, preferably Y being Si.
11. The process according to any of Embodiments 8 to 10, wherein X is Al, and the source for Al₂O₃ includes alumina, aluminates, aluminum alkoxides, aluminum salts, FAU zeolites, LTA zeolites, LTL zeolites, BEA zeolites, MFI zeolites or any combinations thereof.
12. The process according to any of preceding Embodiments 8 to 11, wherein Y is Si and the source for YO₂ includes fumed silica, precipitated silica, silica hydrosols, silica gels, colloidal silica, silicic acid, silicon alkoxides, alkali metal silicates, sodium metasilicate hydrate, sesquisilicate, disilicate, silicic acid esters, FAU zeolites, LTA zeolites, LTL zeolites, BEA zeolites, MFI zeolites or any combinations thereof.
13. The process according to any of preceding Embodiments 8 to 12, wherein the imidazolium based organic structure directing agent is selected from the compounds containing an imidazolium cation of formula (I)

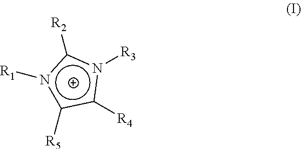

in which
R₁, R₂, R₃, R₄ and R₅, independently from each other, are selected from H, linear or branched alkyl, and mono-, bi- or tricycloalkyl, provided that at least one of R₁ and R₃ is not H.
14. The process according to Embodiment 13, wherein R₁, R₂, R₃, R₄ and R₅, independently from each other, are selected from H and linear or branched C₁-C₁₀ alkyl, provided that at least one of R₁ and R₃ is not H.
15. The process according to any of preceding Embodiments 13 to 14, wherein the imidazolium based organic structure directing agent is selected from the group consisting of compounds containing an imidazolium cation of formula (Ia),

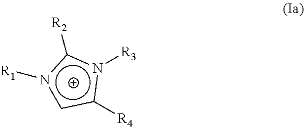

in which
R₁, R₂ and R₄, independently from each other, are selected from the group consisting of H and linear or branched C₁-C₁₀ alkyl, and
R₃ is selected from linear or branched C₁-C₁₀ alkyl.
16. The process according to Embodiment 15, wherein R₁, R₂ and R₄, independently from each other, are selected from the group consisting of H and linear or branched C₁-C₆ alkyl, and R₃ is selected from linear or branched C₁-C₆ alkyl.
17. The process according to Embodiment 16, wherein R₁, R₂ and R₄, independently from each other, are selected from the group consisting of H and linear or branched C₁-C₃ alkyl, and R₃ is selected from linear or branched C₁-C₃ alkyl.
18. The process according to Embodiment 17, wherein R₁, R₂ and R₄, independently from each other, are selected from the group consisting of H, methyl, ethyl, n-propyl and iso-propyl, and R₃ is selected from the group consisting of methyl, ethyl, n-propyl, iso-propyl.
19. The process according to any of Embodiments 8 to 18, wherein the imidazolium based organic structure directing agent is selected from the group consisting of compounds containing an imidazolium cation selected from the group consisting of 1,3-dimethylimidazolium, 1,3-diethylimidazolium, 1,2,3-trimethylimidazolium, 1,2,3-trimethylimidazolium, 1,2,3-triethylimidazolium, 1,3,4-trimethylimidazolium and 1,3,4-triethylimidazolium.
20. The process according to any of Embodiments 8 to 19, wherein the synthesis mixture is characterized by one or more of the following:
   (a) molar ratio of the source for YO₂ calculated as YO₂ to the source for X₂O₃ calculated as X₂O₃ in the range of from 5 to 80, for example 15 to 40, such as 20 to 35, or for example 60 to 80, such as 65 to 75;
   (b) molar ratio of the imidazolium cation (Q) to the source for YO₂ calculated as YO₂ in the range of from 0.01 to 2, preferably from 0.05 to 1.5, more preferably from 0.1 to 1.0, more preferably from 0.2 to 0.8, most preferably from 0.2 to 0.6, particularly 0.4 to 0.6;
   (c) comprising alkali metal and/or alkaline earth metal cations, with molar ratio of the alkali metal and/or alkaline earth metal cations to the source for YO₂ calculated as YO₂ in the range of from 0.01 to 1.0, preferably from 0.1 to 0.8;
   (d) comprising OH—, with molar ratio of OH— to the source for YO₂ calculated as YO₂ in the range of from 0.1 to 2, more preferably from 0.2 to 1.5, more preferably from 0.5 to 1.2, most preferably from 0.6 to 1.2;
   (e) comprising H₂O, with molar ratio of H₂O to the source for YO₂ calculated as YO₂ in the range of from 3 to 60, preferably from 10 to 35, more preferably from 10 to 25, most preferably 10 to 20.
21. The process according to any of preceding Embodiments 8 to 20, further comprising (3) calcining the zeolitic material.
22. The process according to any of preceding Embodiments 8 to 21, further comprising (4) exchanging one or more of ionic non-framework elements contained in the zeolitic material obtained in step (2) or (3) to H⁺ and/or NH₄⁻, preferably NH₄⁻.
23. The process according to any of preceding Embodiments 8 to 22, further comprising (5) loading a promoter metal cation on and/or in the zeolitic material obtained in step (3) or (4).
24. Use of the CHA-like zeolitic material according to any of Embodiments 1 to 7 or the CHA-like zeolitic material obtainable or obtained by the process according to any of preceding Embodiments 8 to 23 as a catalyst and/or as a catalyst component, preferably as a catalyst and/or a catalyst component for the selective catalytic reduction (SCR) of nitrogen oxides NOx.
25. A catalytic article, which comprises a catalytic coating on a substrate, wherein the catalytic coating comprises the CHA-like zeolitic material according to any of Embodiments 1 to 7 or the CHA-like zeolitic material obtainable or obtained by the process according to any of preceding Embodiments 8 to 23.
26. An exhaust gas treatment system, which comprises an internal combustion engine and an exhaust gas conduit in fluid communication with the internal combustion engine, wherein the catalytic article according to Embodiment 25 is present in the exhaust gas conduit.
27. A method for the selective catalytic reduction of NOx comprising
   (A) providing a gas stream comprising NOx;
   (B) contacting the gas stream with a zeolitic material according to any of Embodiments 1 to 7 or the CHA-like zeolitic material obtained by the process according to any of preceding Embodiments 8 to 23.

The invention will be further illustrated by following Examples, which set forth particularly advantageous embodiments. While the Examples are provided to illustrate the present invention, they are not intended to limit it.

### Examples

Scanning electron microscopy (SEM) measurements were performed by a scanning electron microscope (Hitachi SU1510).

X-ray powder diffraction (XRD) patterns were measured with PANalytical X'Pert Pro MPD Diffractometer (45 kV, 40 mA) using CuKα (λ=1.5406 Å) radiation for Sample 1.2, 2, 3 and 4 and with PANalytical X'pert³ Powder Diffractometer (40 kV, 40 mA) using CuKα (λ=1.5406 Å) radiation for other samples, to collect data in Bragg-Brentano geometry.

The optical path consisted of a ⅛° divergence slit, 0.04 radian Soller slits, 15 mm mask, ¼° anti-scatter slit, ⅛° anti-scatter slit, 0.04 radian Soller slits, Ni° filter, and X'Celerator linear position sensitive detector. Data was collected from 3° to 70° 2θ using a step size of 0.0167° 2θ and a count time of 60 s per step.

### Example 1 Preparation of Zeolitic Material with Trimethylimidazolium Hydroxide as OSDA

### Example 1.1 (Sample 1.1

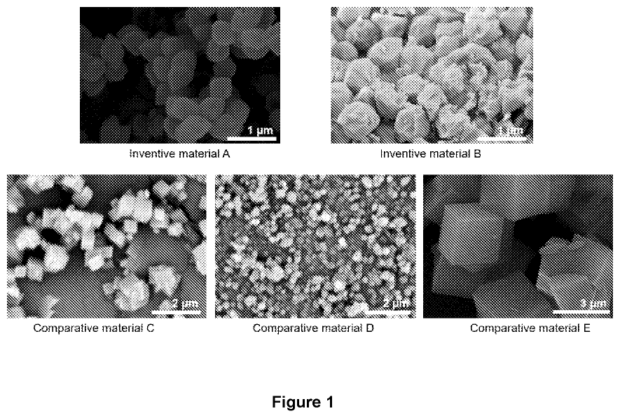

75.2 g of 1,2,3-trimethylimidazolium hydroxide solution (19.6 wt %, 1,2,3-TMI) was mixed with 1.62 g of D.I. Water, followed by the addition of 4.65 g of NaOH (99%, solid). After NaOH dissolves, 1.38 g of HY (SAR(silica to alumina ratio)=5.2, from Shandong Duoyou) was added. Thereafter, 13.89 g fumed silica was slowly added. After stirring at room temperature for 30 min, the gel was transferred into an autoclave. The gel was crystallized at 140° C. for 3 days under rotation. After cooling to room temperature and pressure release, the product was filtered, washed with DI water and dried at 120° C. overnight. The as-synthesized zeolitic material was calcined in air in a furnace at 550° C. for 6 hours, obtaining a zeolitic material having a SAR of 14.4. The calcined zeolite has a crystal morphology as observed from the SEM image shown in FIG. 1.

### Example 1.2 (Sample 1.2

75.2 g of 1,2,3-trimethylimidazolium hydroxide solution (19.6 wt %) was mixed with 1.62 g of D.I. Water, followed by the addition of 4.65 g of NaOH (99%, solid). After NaOH dissolves, 4.14 g of HY (SAR=5.2, from Shandong Duoyou) was added. Thereafter, 13.89 g fumed silica was slowly added. After stirring at room temperature for 30 min, the gel was transferred into an autoclave. The gel was crystallized at 140° C. for 3 days under rotation. After cooling to room temperature and pressure release, the product was filtered, washed with DI water and dried at 120° C. overnight. The as-synthesized zeolitic material was calcined in air in a furnace at 550° C. for 6 hours, obtaining a zeolitic material having a SAR of 14 and an MSA of 37 m²/g and ZSA of 527 m²/g. The calcined zeolite has a crystal morphology as observed from the SEM image shown in FIG. 1.

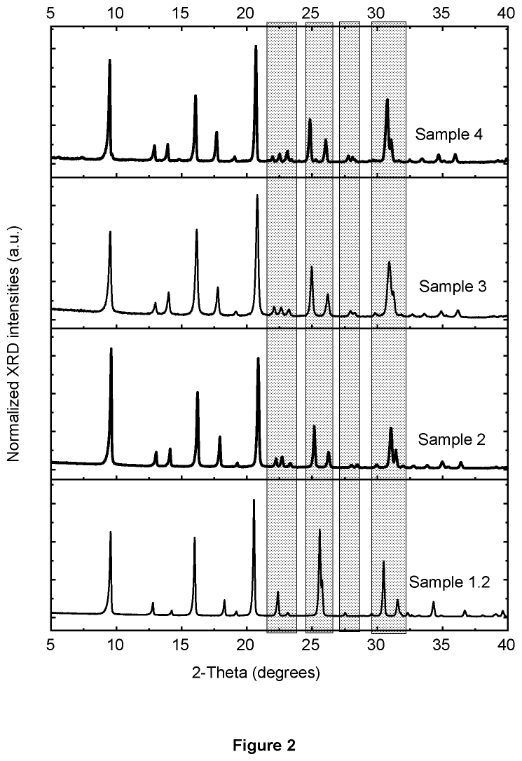

A unique XRD pattern of the as-synthesized form of this sample is shown in FIG. 2 and the peaks are summarized in the Table below.

| 2-Theta | d-spacing | Relative Intensity | |
|---|---|---|---|
| (°) | (Å) | (%) | FWHM |
| 9.56 | 9.24 | 70.9 | 0.16 |
| 12.80 | 6.91 | 10.5 | 0.14 |
| 14.24 | 6.22 | 4 | 0.14 |
| 16.00 | 5.54 | 67.2 | 0.14 |
| 18.28 | 4.85 | 13.4 | 0.13 |
| 19.20 | 4.62 | 3.6 | 0.13 |
| 20.54 | 4.32 | 100 | 0.14 |
| 22.38 | 3.97 | 20.9 | 0.14 |
| 23.14 | 3.84 | 2.7 | 0.12 |
| 25.58 | 3.48 | 74.4 | 0.17 |
| 25.78 | 3.45 | 29.7 | 0.13 |
| 27.54 | 3.24 | 2.8 | 0.13 |
| 28.69 | 3.11 | 0.4 | 0.19 |
| 29.55 | 3.02 | 1.9 | 0.15 |
| 30.48 | 2.93 | 47.1 | 0.15 |
| 31.54 | 2.83 | 13.8 | 0.20 |
| 32.33 | 2.77 | 3 | 0.15 |
| 32.62 | 2.74 | 1.1 | 0.07 |
| 33.18 | 2.70 | 0.8 | 0.16 |
| 34.31 | 2.61 | 12.7 | 0.17 |
| 34.90 | 2.57 | 1 | 0.14 |
| 36.69 | 2.45 | 5.3 | 0.19 |
| 37.06 | 2.42 | 0.7 | 0.25 |
| 38.07 | 2.36 | 1.3 | 0.17 |
| 39.09 | 2.30 | 2.2 | 0.29 |
| 39.60 | 2.27 | 5 | 0.19 |
| 40.33 | 2.23 | 0.3 | 0.13 |

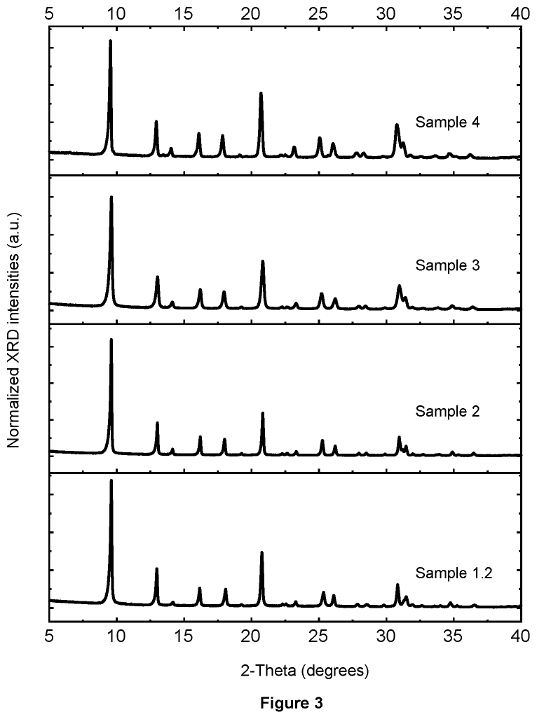

The XRD pattern of the calcined from of this sample is shown in FIG. 3 and the peaks are summarized in the Table below, which is typical of a CHA framework.

| 2-Theta | d-spacing | Relative Intensity | |
|---|---|---|---|
| (°) | (Å) | (%) | FWHM |
| 9.60 | 9.21 | 100 | 9.60 |
| 12.97 | 6.82 | 29.6 | 12.97 |
| 14.18 | 6.24 | 2.7 | 14.18 |
| 16.15 | 5.48 | 14.3 | 16.15 |
| 18.09 | 4.90 | 13.4 | 18.09 |
| 19.24 | 4.61 | 1.1 | 19.24 |
| 20.76 | 4.27 | 43.4 | 20.76 |
| 22.30 | 3.98 | 1.6 | 22.30 |
| 22.57 | 3.94 | 1.7 | 22.57 |
| 23.28 | 3.82 | 3.7 | 23.28 |
| 25.34 | 3.51 | 11.2 | 25.34 |
| 26.09 | 3.41 | 8.5 | 26.09 |
| 27.86 | 3.20 | 1.9 | 27.86 |
| 28.55 | 3.12 | 1.7 | 28.55 |
| 29.82 | 2.99 | 1.1 | 29.82 |
| 30.84 | 2.90 | 17.3 | 30.84 |
| 31.33 | 2.85 | 5.6 | 31.33 |
| 31.47 | 2.84 | 7.8 | 31.47 |
| 31.94 | 2.80 | 1.8 | 31.94 |
| 32.61 | 2.74 | 0.8 | 32.61 |
| 33.58 | 2.67 | 0.6 | 33.58 |
| 34.00 | 2.63 | 0.9 | 34.00 |
| 34.75 | 2.58 | 3.4 | 34.75 |
| 35.23 | 2.55 | 0.9 | 35.23 |
| 36.54 | 2.46 | 1.6 | 36.54 |
| 38.53 | 2.33 | 0.3 | 38.53 |
| 39.07 | 2.30 | 0.5 | 39.07 |
| 39.58 | 2.28 | 0.5 | 39.58 |
| 40.03 | 2.25 | 1.4 | 40.03 |

### Example 1.3 to 1.8

The process as described in Example 1.2 was repeated to provide Samples 1.3 to 1.8. The synthesis mixture and products are summarized in the following Table.

| | Silica | | | | 1,2,3- | | | |
|---|---|---|---|---|---|---|---|---|
| | source | HY | Gel | NaOH | TMI | H₂O | Product | MSA/ZSA |
| No. | (g) | (g) | SAR | (g) | (g) | (g) | SAR | (m²/g) |
| 1.3 | 13.89 | 2.76 | 39.7 | 4.65 | 75.2 | 1.62 | 11.6 | not |
| | (fumed | (SAR 5.2) | | | | | | measured |
| | silica) | | | | | | | |
| 1.4 | 13.89 | 5.53 | 22.45 | 4.65 | 75.2 | 1.62 | 6.21 | 30/464 |
| | (fumed | (SAR 5.2) | | | | | | |
| | silica) | | | | | | | |
| 1.5 | 13.89 | 4.14 | 28.2 | 4.65 | 75.2 | 1.62 | 11.4 | 40/498 |
| | (fumed | (SAR 7.2) | | | | | | |
| | silica) | | | | | | | |
| 1.6 | 13.89 | 4.14 | 28.2 | 4.65 | 75.2 | 1.62 | 13.9 | 37/527 |
| | (fumed | (SAR 12.8) | | | | | | |
| | silica) | | | | | | | |
| 1.7 | 13.89 | 4.14 | 28.2 | 4.09 | 75.2 | 1.62 | 13.8 | 21/539 |
| | (fumed | (SAR 12.8) | | | | | | |
| | silica) | | | | | | | |
| 1.8 | 34.55 | 1.38 | 74.2 | 4.65 | 75.2 | −19.04* | 13.4 | 14/609 |
| | (Ludox | (SAR 5.2) | | | | | | |
| | AS-40) | | | | | | | |

*distilled-off

Unique XRD patterns of the as-synthesized form and CHA XRD patterns of the calcined from were also observed for those samples.

### Example 2 Preparation of Zeolitic Material with Trimethylcyclohexylammonium Hydroxide and Tetramethylammonium Hydroxide as OSDA (Sample 2)

44.2 g of 20 wt % solution of trimethylcyclohexylammonium hydroxide (TMChAOH) was mixed with 4.7 g of D.I. water, followed by the addition of 12.5 g of a 25 wt % solution of tetramethylammonium hydroxide (TMAOH). Thereafter, 5.6 g of aluminum isopropoxide was added and stirred at RT for 1 hour. This was followed by addition of 57.2 g of Ludox® AS-40 and stirring at room temperature for 30 min, and then 0.85 g of calcined CHA zeolite is added as seed before the gel was transferred into an autoclave, the gel was crystallized at 170° C. for 3 days under rotation. After cooling to room temperature and pressure release, the product was filtered, washed with DI water and dried at 90° C. overnight. The as-synthesized zeolitic material was calcined in air in a furnace at 540° C. for 6 hours, obtaining a zeolitic material having a SAR of 26.3 and an MSA of 44 m²/g and ZSA of 527 m²/g. The calcined zeolite has a crystal morphology as observed from the SEM image shown in FIG. 1.

XRD patterns of the as-synthesized and calcined forms of the zeolitic material are shown in FIGS. 2 and 3 respectively, which are typical of a CHA framework.

### Example 3 Preparation of Zeolitic Material with N,N,N-Trimethyladamantammonium Hydroxide as OSDA (Sample 3)

25.6 g of 20 wt % solution of N,N,N-trimethyladamantammonium hydroxide (TMAdaOH) was mixed with 12.4 g of D.I. water, followed by the addition of 3.5 g of 50 wt % NaOH solution. Thereafter, 7.1 g of aluminum isopropoxide was added and stirred at room temperature for 1 hour. This was followed by addition of 51.4 g of Ludox® AS-40 and stirring at room temperature for 30 min. Then the gel was transferred into an autoclave, and crystallized at 170° C. for 3 days under rotation. After cooling to room temperature and pressure release, the product was filtered, washed with DI water and dried at 90° C. overnight. The as-synthesized zeolitic material was calcined in air in a furnace at 540° C. for 6 hours, obtaining a zeolitic material having a SAR of 19.4 and an MSA of 43 m²/g and ZSA of 512 m²/g. The calcined zeolite has a crystal morphology as observed from the SEM image shown in FIG. 1.

XRD patterns of the as-synthesized and calcined forms of the zeolitic material are shown in FIGS. 2 and 3 respectively, which are typical of a CHA framework.

### Example 4 Preparation of Zeolitic Material with N,N,N-Trimethyladamantammonium Hydroxide as OSDA (Sample 4)

A solution of 77.3 g of D.I. water, 5.3 g of 20 wt % solution of TMAdaOH, 1 g of sodium sulfate and 0.8 g of 50 wt % NaOH solution was stirred at room temperature for 10 min. Thereafter, 3.2 g of FAU zeolite (CBV 100, SAR=5.1) was added and stirred for 45 min, followed by addition of 32.4 g of sodium silicate and stirring for 30 min. Then the gel was transferred into a 0.3 L autoclave, and crystallized at 140° C. for 3 days under rotation. After cooling to room temperature and pressure release, the product was filtered, washed with DI water and dried at 90° C. overnight. The as-synthesized zeolitic material was calcined in air in a furnace at 540° C. for 6 hours, obtaining a zeolitic material having a SAR of 11.1 and an MSA of 3 m²/g and ZSA of 535 m²/g. The calcined zeolite has a crystal morphology as observed from the SEM image shown in FIG. 1.

XRD patterns of the as-synthesized and calcined forms of the zeolitic material are shown in FIGS. 2 and 3 respectively, which are typical of a CHA framework.

It has been found that a novel CHA-like zeolitic material was synthesized by using an imidazolium based organic structure directing agent, which shows an XRD pattern different from that of a typical CHA framework in the as-synthesized from, but shows a typical XRD pattern of CHA framework in the calcined form.

### Example 5 Test of Catalyst Performance

### Preparation of Cu-Loaded Zeolitic Material

The zeolitic material from Example 1.1 upon crush was added into 10 wt % aqueous NH₄Cl solution at a liquid to solid ratio of 10:1 by weight. The obtained slurry was heated to 80° C. and kept for 2 hour, and then filtered, washed with D.I. water, and dried at 110° C. overnight. The ion-exchange procedure was repeated once and the dried product was calcined at 450° C. for 6 hours, obtaining the H-form zeolite.

The H-form zeolite powder was impregnated with an aqueous copper (II) nitrate solution by incipient wetness impregnation and stored at 50° C. for 20 h in a sealed container. The obtained solid was dried and calcined in air in a furnace at 450° C. for 5 hours, to obtain a Cu-loaded zeolite with 5.1 wt % CuO (Cu/Al ratio being about 0.33).

### Test on Aged Catalyst Sample

The test sample was prepared by slurrying the Cu-loaded zeolite with an aqueous solution of Zr-acetate and then dried at ambient temperature in air under stirring, and then calcined at 550° C. for 1 hour to provide a product containing 5 wt % ZrO₂ as the binder based on the amount of the product. The obtained product was crushed and then the fraction of 250-500 microns was aged at 650° C. in a flow of 10 vol % steam/air for 50 hours.

The selective catalytic reduction (SCR) measurement was carried out in a fixed-bed reactor with loading of 120 mg of the test sample together with corundum of the same sieve fraction as diluent to about 1 mL bed volume, in accordance with following conditions:
Gas feed: 500 ppm NO, 500 ppm NH₃, 5% H₂O, 10% O₂ and balance of N₂, with gas hourly space velocity (GHSV) 80,000 h⁻¹;
Temperature: RUN1—200, 400, 575° C. (first run for degreening)
   RUN2—175, 200, 225, 250, 350, 450, 550, 575° C.

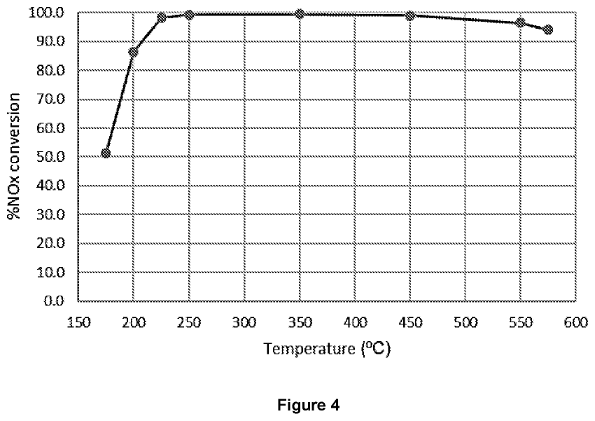

Results from RUN 2 at various temperatures are summarized in the Table below and also shown in FIG. 4. It can be seen that the Cu-promoted zeolite according to the present invention is effective for removal of NOx.

| Temperature, ° C. | NOx conversion, % |
|---|---|
| 175 | 51.3 |
| 200 | 86.3 |
| 225 | 98.2 |
| 250 | 99.2 |
| 350 | 99.3 |
| 450 | 99.0 |
| 550 | 96.4 |
| 575 | 94.0 |

1. A CHA-like zeolitic material having an X-ray diffraction pattern including the following peaks, in its as-synthesized form:

| 2-Theta | d-spacing | Relative Intensity |
|---|---|---|
| (±0.3°) | (Å) | (±30%) |
| 9.56 | 9.24 | 71 |
| 16.00 | 5.54 | 67 |
| 20.54 | 4.32 | 100 |
| 22.38 | 3.97 | 21 |
| 25.58 | 3.48 | 74 |
| 25.78 | 3.45 | 30 |
| 30.48 | 2.93 | 47 |

or having an X-ray diffraction pattern including the following peaks,

| 2-Theta | d-spacing | Relative Intensity |
|---|---|---|
| (±0.3°) | (Å) | (±30%) |
| 9.56 | 9.24 | 71 |
| 12.80 | 6.91 | 11 |
| 16.00 | 5.54 | 67 |
| 18.28 | 4.85 | 13 |
| 20.54 | 4.32 | 100 |
| 22.38 | 3.97 | 21 |
| 25.58 | 3.48 | 74 |
| 25.78 | 3.45 | 30 |
| 27.54 | 3.24 | 3 |
| 30.48 | 2.93 | 47 |
| 31.54 | 2.83 | 14 |
| 32.33 | 2.77 | 3 |

or having an X-ray powder diffraction pattern including the following peaks

| 2-Theta | d-spacing | Relative Intensity |
|---|---|---|
| (±0.3°) | (Å) | (±30%) |
| 9.56 | 9.24 | 71 |
| 12.80 | 6.91 | 11 |
| 16.00 | 5.54 | 67 |
| 18.28 | 4.85 | 13 |
| 20.54 | 4.32 | 100 |
| 22.38 | 3.97 | 21 |
| 23.14 | 3.84 | 3 |
| 25.58 | 3.48 | 74 |
| 25.78 | 3.45 | 30 |
| 27.54 | 3.24 | 3 |
| 28.69 | 3.11 | 0.4 |
| 29.55 | 3.02 | 2 |
| 30.48 | 2.93 | 47 |
| 31.54 | 2.83 | 14 |
| 32.33 | 2.77 | 3 |
| 34.31 | 2.61 | 13. |

2. The CHA-like zeolitic material according to claim 1, which has an X-ray diffraction pattern including the following peaks, in its calcined form:

| 2-Theta | d-spacing | Relative Intensity |
|---|---|---|
| (±0.3°) | (Å) | (±30%) |
| 9.60 | 9.21 | 100 |
| 12.97 | 6.82 | 30 |
| 16.15 | 5.48 | 14 |
| 18.09 | 4.90 | 13 |
| 20.76 | 4.27 | 43 |
| 25.34 | 3.51 | 11 |
| 30.84 | 2.90 | 17. |

3. The CHA-like zeolitic material according to claim 1, which has a mixed morphology wherein partial crystals show cuboctahedral morphology and the other crystals show non-convex polyhedral morphology, as observed by scanning electron microscopy.

4. The CHA-like zeolitic material according to claim 1, which, in its as-synthesized form, comprises imidazolium cations, particularly imidazolium cations of formula (1) 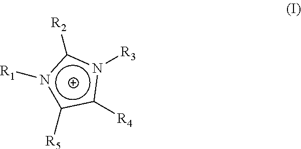
in which
R₁, R₂, R₃, R₄ and R₅, independently from each other, are selected from H, linear or branched alkyl, and mono-, bi- or tricycloalkyl, provided that at least one of R₁ and R₃ is not H;
preferably imidazolium cations of formula (1) in which R₁, R₂, R₃, R₄ and R₅, independently from each other, being selected from H and linear or branched C₁-C₁₀ alkyl, provided that at least one of R₁ and R₃ is not H;
more preferably imidazolium cations of formula (Ia) 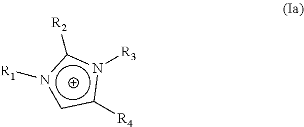
in which
R₁, R₂ and R₄, independently from each other, are selected from the group consisting of H and linear or branched C₁-C₁₀ alkyl, and
R₃ is selected from linear or branched C₁-C₁₀ alkyl.

5. The CHA-like zeolitic material according to claim 4, wherein the imidazolium cations are selected from the group consisting of 1-ethyl-3-methylimidazolium, 1,3-dimethylimidazolium, 1,3-diethylimidazolium, 1,2,3-trimethylimidazolium, 1,2,3-trimethylimidazolium, 1,2,3-triethylimidazolium, 1,3,4-trimethylimidazolium and 1,3,4-triethylimidazolium.

6. The CHA-like zeolitic material according to claim 1, which has at least one of following surface areas:
(1) a mesopore surface area (MSA) of no more than 60 m²/g, or no more than 50 m²/g, or no more than 45 m²/g, for example 10 to 60 m²/g, or 10 to 50 m²/g or 10 to 45 m²/g; and
(2) a zeolitic surface area (ZSA) of at least about 400 m²/g, or at least 450 m²/g, for example in the range of 400 to 650 m²/g or 450 to 650 m²/g.

7. The CHA-like zeolitic material according to claim 1, which is an aluminosilicate zeolite.

8. A process for preparing a CHA-like zeolitic material according to claim 1, which comprises
(1) providing a synthesis mixture comprising
(a) a source for X₂O₃ where X is a trivalent element,
(b) a source for YO₂ where Y is a tetravalent element, and
(c) an imidazolium based organic structure directing agent, and
(2) heating the synthesis mixture to form a zeolitic material.

9. The process according to claim 8, wherein X is selected from the group consisting of Al, B, In and Ga and any combinations thereof and wherein Y is selected from the group consisting of Si, Sn, Ti, Zr, Ge and any combinations thereof.

10. (canceled)

11. The process according to claim 8, wherein X is Al, and the source for Al₂O₃ includes alumina, aluminates, aluminum alkoxides, aluminum salts, FAU zeolites, LTA zeolites, LTL zeolites, BEA zeolites, MFI zeolites or any combinations thereof, and wherein Y is Si and the source for YO₂ includes fumed silica, precipitated silica, silica hydrosols, silica gels, colloidal silica, silicic acid, silicon alkoxides, alkali metal silicates, sodium metasilicate hydrate, sesquisilicate, disilicate, silicic acid esters, FAU zeolites, LTA zeolites, LTL zeolites, BEA zeolites, MFI zeolites or any combinations thereof.

12. (canceled)

13. The process according to claim 8, wherein the imidazolium based organic structure directing agent is selected from the compounds containing an imidazolium cation of formula (I) 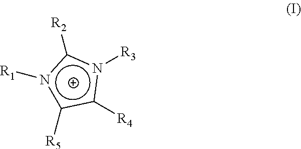
in which
R₁, R₂, R₃, R₄ and R₅, independently from each other, are selected from H, linear or branched alkyl, and mono-, bi- or tricycloalkyl, provided that at least one of R₁ and R₃ is not H.

14. The process according to claim 13, wherein R₁, R₂, R₃, R₄ and R₅, independently from each other, are selected from H and linear or branched C₁-C₁₀ alkyl, provided that at least one of R₁ and R₃ is not H.

15. The process according to claim 13, wherein the imidazolium based organic structure directing agent is selected from the group consisting of compounds containing an imidazolium cation of formula (Ia), 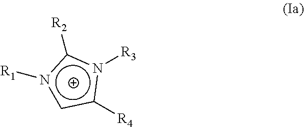
in which
R₁, R₂ and R₄, independently from each other, are selected from the group consisting of H and linear or branched C₁-C₁₀ alkyl, and
R₃ is selected from linear or branched C₁-C₁₀ alkyl.

16. The process according to claim 15, wherein R₁, R₂ and R₄, independently from each other, are selected from the group consisting of H and linear or branched C₁-C₆ alkyl, and R₃ is selected from linear or branched C₁-C₆ alkyl.

17. (canceled)

18. (canceled)

19. The process according to claim 8, wherein the imidazolium based organic structure directing agent is selected from the group consisting of compounds containing an imidazolium cation selected from the group consisting of 1,3-dimethylimidazolium, 1,3-diethylimidazolium, 1,2,3-trimethylimidazolium, 1,2,3-trimethylimidazolium, 1,2,3-triethylimidazolium, 1,3,4-trimethylimidazolium and 1,3,4-triethylimidazolium.

20. The process according to claim 8, wherein the synthesis mixture is characterized by one or more of the following:
(a) molar ratio of the source for YO₂ calculated as YO₂ to the source for X₂O₃ calculated as X₂O₃ in the range of from 5 to 80, for example 15 to 40, such as 20 to 35, or for example 60 to 80, such as 65 to 75;
(b) molar ratio of the imidazolium cation (Q) to the source for YO₂ calculated as YO₂ in the range of from 0.01 to 2, preferably from 0.05 to 1.5, more preferably from 0.1 to 1.0, more preferably from 0.2 to 0.8, most preferably from 0.2 to 0.6, particularly 0.4 to 0.6;
(c) comprising alkali metal and/or alkaline earth metal cations, with molar ratio of the alkali metal and/or alkaline earth metal cations to the source for YO₂ calculated as YO₂ in the range of from 0.01 to 1.0, preferably from 0.1 to 0.8;
(d) comprising OH—, with molar ratio of OH— to the source for YO₂ calculated as YO₂ in the range of from 0.1 to 2, more preferably from 0.2 to 1.5, more preferably from 0.5 to 1.2, most preferably from 0.6 to 1.2;
(e) comprising H₂O, with molar ratio of H₂O to the source for YO₂ calculated as YO₂ in the range of from 3 to 60, preferably from 10 to 35, more preferably from 10 to 25, most preferably 10 to 20.

21. The process according to claim 8, further comprising (3) calcining the zeolitic material, (4) exchanging one or more of ionic non-framework elements contained in the zeolitic material obtained in step (2) or (3) to H⁺ and/or NH₄+, and (5) loading a promoter metal cation on and/or in the zeolitic material obtained in step (3) or (4).

22. (canceled)

23. (canceled)

24. (canceled)

25. A catalytic article, which comprises a catalytic coating on a substrate, wherein the catalytic coating comprises the CHA-like zeolitic material according to claim 1 or the CHA-like zeolitic material obtainable or obtained by the process according to claim 8.

26. An exhaust gas treatment system, which comprises an internal combustion engine and an exhaust gas conduit in fluid communication with the internal combustion engine, wherein the catalytic article according to claim 25 is present in the exhaust gas conduit.

27. A method for the selective catalytic reduction of NOx comprising
(A) providing a gas stream comprising NOx;
(B) contacting the gas stream with a zeolitic material according to claim 1 or the CHA-like zeolitic material obtained by the process according to claim 8.
